(19) United States
(12) Patent Application Publication
(10) Pub. No.: US 2025/0383103 A1
(43) Pub. Date: Dec. 18, 2025

(54) ROOM AIR CLEANER WITH LOW-PRESSURE FILTER

(71) Applicant: KAPPA FILTER SYSTEMS GMBH, Steyr-Gleink (AT)

(72) Inventors: Klaus KRÜGER, Steyr/St. Ulrich (AT); Urs HUNZIKER, Meilen (CH)

(73) Assignee: KAPPA FILTER SYSTEMS GMBH, Steyr-Gleink (AT)

(21) Appl. No.: 18/877,425

(22) PCT Filed: Jun. 28, 2023
(86) PCT No.: PCT/EP2023/067729

§ 371 Date: Dec. 20, 2024

(30) Foreign Application Priority Data
Jul. 1, 2022 (DE) 10 2022 116 527.2

(51) Int. Cl. F24F 8/108; F24F 11/74; F24F 13/24; F24F 13/28; F24F 130/40

(52) U.S. Cl. CPC F24F 8/108; F24F 11/74; F24F 13/24; F24F 13/28; F24F 2013/247; F24F 2130/40; F24F 2221/02

(57) ABSTRACT

The present disclosure relates to a filter device for filtering air in a room of a building. The filter device comprises a filter medium and a fan unit, wherein air to be filtered can be flowed through the filter medium for filtering by means of the fan unit. A filter area of the filter medium is five times larger than a smallest air flow cross-section in the fan unit, such that an air flow angle between the flow direction of the air during filter entry into the filter medium and a filter surface of the filter medium differs from 90 degrees and the sound pressure level of the filter device.

### TECHNICAL FIELD

The present invention relates to a filter device for filtering air in a room of a building and a method for filtering air in a room of a building using a filter device.

### BACKGROUND OF THE INVENTION

Filter systems in room air systems ensure the ventilation and venting of rooms in buildings and filter pollutants from the air. Primary filter plants are used in buildings which comprise, for example, central ventilation plants in a building and controlled ventilation of apartments. The primary filter plants can have a connection to the outside air. In addition, secondary filter plants are often used as a supplement to the primary filter plants. A secondary filter plant comprises, for example, an air circulation system with filtering and is provided for installation in a room (for example room air cleaner).

Secondary filter plants for air cleaning often have a smaller air throughput than the primary ventilation plants, so that, for example, aerosols in the air can only be filtered insufficiently to reduce possible viral loads on the contaminated room air to a sufficiently small extent in a sufficiently short time. The aerosols exhaled by humans contaminate the room air and contain a risk of contagion for others present. More powerful secondary ventilation plants, on the other hand, are often loud, so that the persons in the room perceive this as disturbing.

This relates in particular to offices, event halls, meeting rooms and training rooms with a high occupancy of humans per square meter. In order to achieve a meaningful aerosol depletion in such environments, the required air conversion increases more than just linearly, with which the associated acoustic load also increases exponentially.

### SUMMARY OF THE INVENTION

It is an object of the present invention to provide a filter device having a high power and low operating noise.

According to a first aspect of the present invention, a filter device for filtering air in a room of a building is described. The filter device comprises a filter medium and a fan unit, wherein air to be filtered can be flowed through the filter medium for filtering by means of the fan unit. A filter area of the filter medium is five times larger than a smallest air flow cross-section in the fan unit, such that an air flow angle between the flow direction of the air during filter entry into the filter medium and a filter surface of the filter medium differs from 90 degrees and the sound pressure level of the filter device at a distance of one meter from the filter device at a volume flow rate above 50 m³/h of the air driven by the fan unit is below 48 dB, wherein the filter medium is configured such that the pressure drop of the air which flows through the filter medium is less than 450 Pascal.

According to a further aspect, a method for filtering air in a room of a building using a filter device described above is shown.

A filter device according to the invention is typically used in buildings for filtering and cleaning air or also for cleaning air in production processes of factories.

The filter device comprises, for example, a housing in which a filter medium is arranged or a plurality of filter media are arranged in series along the flow direction of the air through the filter device or parallel to the flow direction. The filter medium can be replaceably provided.

The filter medium of the filter device comprises, for example, a flat filter material which is fixed in a circumferential support frame. The filter medium can be designed as a pocket filter, wherein a plurality of pockets of filter medium are fastened in the support frame and the air flow is introduced into the pockets in order to filter the inflowing air. Furthermore, the filter medium can also be designed as a cartridge filter, hose filter, candle filter, compact filter and HEPA filter.

The fan unit of the filter device in particular sucks air to be filtered into the filter device, so that the air flows through the filter medium. The fan unit can comprise, for example, an axial compressor or a radial compressor and accordingly the air can flow in a straight line or at right angles along a translational flow. The fan unit can in particular be controlled by the control unit, so that the air throughput through the filter device can be adjusted. The fan unit is in particular a secondary air circulation system with filtering for installation in a room (so-to-speak a “room air cleaner”). The filter device can be mobile or stationary.

According to the invention, the filter area of the filter medium is at least five times larger than a smallest air flow cross-section in the fan unit. The smallest air flow cross-section describes the smallest flow cross-section in the air path of the air through the filter device, i.e. between the entry of the air and the exit of the air into and out of the filter device. The smallest flow cross-section can, for example, be present in an air channel of the filter device in which a flow-generating element (e.g. a fan) of the fan unit is arranged.

The filter medium is arranged in particular downstream of the smallest air flow cross-section. Between the smallest air flow cross-section and the filter medium, the air flow cross-section of the air path through the filter device widens, so that the air strikes a filter medium which comprises a filter area which is five times larger than the smallest air flow cross-section in the fan unit. Alternatively, the filter medium can also be mounted in front of the fan, i.e. the system operates in suction mode. This has the advantage that the fan is less polluted and the air inlet is better sound-insulated, so that it can be arranged closer to the head of a person without increasing the noise emission.

Between the filter medium and the smallest air flow cross-section, there is exclusively a widening of the air flow path, so that a linear portion of the air flow against the filter medium during filter entry comprises a flow direction differing from 90 degrees to a filter surface of the filter medium. In particular, the filter surface is parallel to the smallest air flow cross-section or parallel to an air flow cross-section before the widening of the air flow path begins. In other words, a first air flow cross-section of a widening region of the air path is parallel to a further air flow cross-section of the widening region formed downstream, at which the filter surface of the filter medium is present.

The widening region further forms a long expansion zone without, for example, hard transitions after the fan. Especially good results were found when the expansion zone is larger or longer than the cross-section of the air flow, in particular more than twice or even four times the cross-section of the air flow.

With this widening it is achieved that the flow direction of the air during filter entry at the filter surface comprises a filter entry angle differing from 90 degrees. In particular, this applies to 95%, in particular 99%, of the volume flow of the air which flows against the filter surface.

If the air guidance is constructed in such a way that the main flow direction of the air at the filter surface at the inlet of the filter medium is not guided in a straight line through the filter medium, but instead a deflection, for example of more than 10 degrees, takes place for the majority, a rotational movement is introduced precisely for larger particle or aerosol portions of the air, which achieve a better separation rate on a filter (in particular in combination effect with multi-layer porous filter together with cyclone separation effect). The cyclone separation effect allows a more stable binding of the foreign substances. The inertial movement of heavier air flow portions achieved by the air deflection leads to a better adherence to the filter material in the filter medium and thereby a better separation rate.

By means of this widening of the flow cross-section it is achieved that the sound pressure level of the filter device at a distance of one meter from the filter device (in particular from the air outlet and/or the air inlet of the filter device) at a volume flow rate above 50 m³/h of the air driven by the fan unit is below 48 dB.

The filter medium is configured here (for example with via the material/pore density, the material selection and/or the thickness of the filter medium) such that the pressure drop (between entry into the filter medium and exit from the filter medium) of the air which flows through the filter medium is less than 450 Pascal. The filter performance of the filter device according to the invention, in particular of the filter medium, is measured, for example, according to EN ISO 16890, and is better than 50% for one of the classes “ISO Coarse”, “ISO ePM10”, “ISO ePM2,5” or “ISO ePM1”.

A reduction of the pressure drop is thus achieved via the filter medium and its generous dimensioning of the filter surface and construction of the filter medium. A high air throughput has the effect that virus-contaminated aerosols are first deposited on the filter medium, but then rapidly dried by the high air flow. As a result, in particular enveloped viruses die very rapidly, since they dry.

When the filter area is larger, in particular significantly larger, than the inflow cross-section or the air flow cross-section in the fan unit of the air to be cleaned, a change in speed of the air flow also takes place as a result. Highly accelerated heavy solid fractions (or aerosols) reduce their velocity more slowly than the light air molecules. This means that they strike the filter membrane relatively strongly, which in turn leads to a good adherence to the filter (and thus to a particularly good depletion). Thus, it has turned out that good sound values are possible when the filter area is more than 5 times larger, in particular more than 10 times larger, in particular more than 20 times larger, preferably more than 40 times larger, than the smallest air flow cross-section in the fan unit. A corresponding enlargement of the filter area leads to a further reduction of noise level of the flowing air and to an improved filter performance.

According to a further exemplary embodiment, the filter medium is formed with an (absolute) filter area larger than 1 m², in particular larger than 2 m², in particular larger than 4 m², in particular larger than 8 m². The filter area forms the area of the filter medium against which the air flows. The filter area on the inflow side of the filter medium has, for example, the same size as the filter area on the outflow side of the filter medium.

The filter device comprises in particular an outlet opening through which the filtered air can flow out. The filter medium can be arranged in the filter device such that the filter area can be visually perceived from outside the filter device. In other words, the filter area is freely accessible from the outside, without noise-generating flow obstacles being provided for the outflowing air. With such a large filter area of the filter medium, a diffuser for the sound generated by the air flow becomes larger. In addition, due to its size, the large filter area comprises filter regions which can be further away from the ear of a person, so that the filter regions are then further away from the ear of the sound misperception and lead to a summarily smaller perceivable sound level. Together with the configuration of the dimension of the filter medium and the configuration of the filter medium with respect to the pressure drop of the air flowing through (for example via the material selection and the thickness of the filter medium), technical measures are described according to the invention which lead to a high filter performance with a low noise level.

A filter area configured in this way can contain, and/or be configured accordingly, stabilizing, fastening or stiffening components on the inner side or outer side (such as, for example, a support frame, a holding rail in which the filter medium can be inserted or a plastic strip connected to the filter for fastening). This counteracts an oscillation or vibration of the filter medium in the flow air and thus acts indirectly in a noise-inhibiting manner.

The present invention relates in particular to a secondary filter plant which, due to a filter medium having a particularly low pressure drop, makes it possible to filter large air volumes with low, low noise emissions and in particular to achieve a relevant depletion of aerosols.

According to a further exemplary embodiment, the filter area of the filter medium is formed larger than a smallest air flow cross-section in the fan unit such that at a distance of one meter the sound pressure level of the filter device is below 45 dB, in particular below 38 dB, in particular below 32 dB, further in particular below 28 dB.

According to a further exemplary embodiment, the filter medium is formed such that a pressure drop of the through-flowing air through the filter medium is below 250 Pa, in particular below 150 Pa, further in particular below 70 Pa or 30 Pa.

According to a further exemplary embodiment, the filter device is configured such that an air volume per hour and square meter of filter area (i.e. the filter area load) is below 600 m³/(m²×h), in particular below 140 m³/(m²×h), below 85 m³/(m²×h) or below 50 m³/(m²×h), and/or the velocity of the volume flow of the air 103 through the filter device 100 is in the range 0.1 to 5 m/s, in particular in the range 0.2 m/s to 3.4 m/s, further in particular between 0.3 m/s to 2.8 m/s. These characteristic values can in particular be adjusted by the selection of the filter size, the filter material and the design of the fan unit.

According to a further exemplary embodiment, the filter device has a microphone unit and a sound generator, wherein the microphone unit is arranged to measure the sound level of the air before the fan unit and/or after the filter medium, wherein the sound generator is configured to generate a counter sound based on the measured sound level. An active noise suppression can thus be integrated. The sound generator thereby generates sound which is adjusted such that it is adjusted with a destructive interference with respect to the sound which the air flow generates. In addition, a counter signal is generated which corresponds to that of the disturbing sound, but has opposite polarity. The sound generator thus generates counter sound based on the air flow sound recorded by the microphone unit or modulates it. This has the advantage that the sound generator implicitly covers the noises of the air flow as a sound source.

According to a further exemplary embodiment, the filter device, e.g. the housing thereof, has an air outlet for blowing out the air, wherein the filter device is formed such that the air outlet is lower than 1 m, in particular lower than 0.5 m, above the ground (or the standing surface on which the filter device rests). Additionally or alternatively, the filter device is formed such that the air outlet is higher than 1.8 m, in particular higher than 2 m, above the ground. In the plurality of installation sites for secondary filter systems, the plurality of people located therein will have their ears more than one meter above the ground and less than 2 m or 1.80 m. This allows a constructive optimization such that noise-emission-strong components such as fans or suction openings or air outlets are formed on the ground or towards the ground or are formed above the height of 1.80 m above the ground.

Accordingly, the noise load can also be measured from one meter and below 2 m from the ground. Especially by placing filter devices with an outlet region in the zone above one meter from the ground, it allows the acoustic diffusion effect of the much larger filter area compared to the smallest air flow cross-section (e.g. in the fan) to be used for noise reduction. The same topic applies to noise sources which are installed more than 1.8 m above the ground. Thus, for example, a filter device with a housing with the function of a ceiling lamp and the filter function represents a construction ideal in terms of noise.

According to a further exemplary embodiment, the filter device has a control unit for controlling the fan unit, wherein the control unit is coupled to the fan unit for a wireless or wired signal exchange of control commands. The control unit can be integrated in the filter device and control the fan unit. Furthermore, the control unit can form a central control unit which is arranged outside the filter device and controls, for example, multiple filter devices.

According to a further exemplary embodiment, the filter device has a sensor element for determining at least one air parameter (e.g. CO content, CO₂ content, rel. air humidity, air pressure, O₂ content, temperature, PM content, aerosol concentration, type and/or concentration of foreign substances) of the air to be filtered at the filter device or an operating parameter of the filter device. The control unit is coupled for a wireless (or wired) signal exchange of sensor signals of the sensor element. The sensor element can provide, for example, air quality-related and/or filter-related data to the control unit, in particular by means of RFID, NFC, Bluetooth, WLAN or protocols of building control technology. The control unit is configured in particular such that a warning signal can be generated on the basis of the filter-related data and/or a measure can be taken which relates to a throughput through the filter device (e.g. control of the fan unit) or relates to functions of the filter device which are blocked or released.

The filter device and the control unit can each comprise an antenna or a conductor-based system which signals the readiness of the filter device to exchange data. Such data can relate not only to parameters regarding the air accompanying substances of the air, but also contain information and details of the filter device. Thus, for example, depending on the performance of a filter device used, the air volume can be adapted by the filter device. Furthermore, if a transit time or occupation density of the filter medium is exceeded, a signal can be emitted which can either be interpreted as a maintenance signal or can also be used as a control signal in order to reduce or increase the air throughput quantity. An embodiment variant of a transmitting device in the filter device and/or the control unit can be an RFID transponder (which, for example, also comprises filter data in encrypted form). Furthermore, other communication mechanisms such as NFC, Bluetooth, WLAN etc. can also be used. For wired communication, in addition to proprietary protocols, bus systems of building control systems (LON, EIB, etc.) are also available.

Since secondary filter devices are usually operated without maintenance organization, a high filter occupation (due to filter changes which are due but not carried out) is a further source for higher noise emissions (e.g. because the air throughput monitoring then operates the fan with higher power). For this reason, a filter occupation monitoring is installed in the filter device, in particular with a transmission possibility for the detected fault, which reaches further than the local surroundings of the filter device (e.g. wired or wireless transmission of the fault message “filter fully/exchange”). In particular, an external service team can thus be requested and/or invited.

According to a further exemplary embodiment, the sensor element is a dynamic pressure gauge and is formed in particular such that a static pressure upstream of the filter medium and a static and dynamic pressure downstream of the filter medium can be measured. If the velocity of the air flow is high enough, the differential pressure between a normal pressure tap upstream of the filter medium and a dynamic pressure pipe (or Pitot pipe) downstream of the filter medium can be measured. The pressure at the Pitot pipe is given by the sum of the static pressure and the dynamic pressure and is therefore higher than at the normal pressure tap upstream of the filter medium. This configuration creates an inverted or negative differential pressure across the filter medium and allows clogged supply lines or flap faults to be detected. This embodiment can be suitable in particular for retrofitting older plants. By using the control unit in the filter device, it becomes possible to parameterize the response and/or limit values in the filter device from the outside.

The sensor element can comprise, for example, a microphone and detect the noise level in the room and in particular the location of a noise source. By measuring and evaluating the noise level in a room, it is possible to infer the number and intensity of speech-active persons in the room and the ventilation power of the fan unit can be adapted thereto via the control unit, since the emission of aerosols by persons increases with the speech volume. In other words, the regulation of the ventilation power can thus be adjusted via the noise level in the room. The more persons speak, or speak loudly, the more aerosols are emitted and the higher the ventilation power can be, since then, for example, the additional sound of the devices, such as, for example, the fan unit, is not perceived and does not disturb. If one or more persons sit still in the room, the ventilation power goes down, because it must be quiet for concentrated work, but also hardly any aerosols are emitted.

According to a further exemplary embodiment, the control unit obtains a UniqueID from the filter device, wherein the UniqueID comprises information regarding the location of use of the filter device. The control unit receives the UniqueID via NFC, Bluetooth, WLAN, proprietary protocols or protocols of building control systems, in particular LON or EIB, wherein the operation and/or the configuration of the filter device can be adjusted based on the UniqueID. In a further especially preferred embodiment, the UniqueID comprises information regarding the installation location of the filter device in the filter system. This ID allows, from a preconfigured operating mode of the filter device, to preselect the operating parameters required for the specific operation or to retrieve stored data of a system configuration. In particular when using encrypted protocols, a new configuration can thus be avoided during filter change and a ‘plug and play’ can be implemented. Corresponding data can be transmitted by the filter device during change or can be transferred via cloud. The transmission of the UniqueID to the filter system can take place using mechanisms known to the person skilled in the art using QR code, barcode, OCR fonts (and their successors for machine-readable fonts), RFID, NFC, Bluetooth, WLAN, proprietary protocols or protocols of building control systems (LON, EIB, etc.). By means of this mechanism, it is also possible to deliver a filter device in which functions are only enabled if a part of the UniqueID belongs to the agreed delivery scope.

According to a further exemplary embodiment, the filter device further has a data storage unit, which is coupled to the control unit, to the fan unit and to the sensor element for exchanging data, wherein in particular the data can be protected by means of a certificate and/or an encryption. The data represent in particular measured values, which are selected from the group consisting of air throughput through the filter device, air temperature, air pressure, in particular absolute pressure and/or differential pressure, filter occupancy of the filter medium, air humidity, aerosol loading, PM content and/or foreign substance fraction of the air, measuring location of the air measurement. Especially in the case of demanding operating conditions, it can be of interest that individual detection details, such as the measured values, can be parameterized. On the one hand, this relates to details of the measuring method, on the other hand also the parameters which are to be recorded (e.g. air throughput, temperature, pressure (in particular absolute pressure and/or differential pressure), filter occupancy, humidity, aerosol loading, PM content, in particular also how much of which diameter class). Such a data record can then in turn be transmitted by means of a communication or can only be read out after the end of the filter service life.

According to a further exemplary embodiment, the sensor element is configured to determine an energy consumption and/or a CO2 footprint of the filter device based on the air parameter and/or the operating parameter of the filter device, in particular filter occupancy and/or operating time of the filter medium. The air parameters and/or operating parameters of the filter device are in particular selected to determine a recommendation regarding filter change and/or filter cleaning, in particular such that individual parameters can be configured thereby. For example, a permanent and continuous optimization of energy consumption and CO2 footprint (at most in real time) is made. Thus, it can for example be advantageous to exchange a filter before ‘end of life’ (e.g. a maximum filter occupancy), since an exponentially increasing pressure drop across the filter occurs due to the filter occupancy within the framework of the service life. Depending on energy costs or requirements for the CO2 footprint of the filter device, a filter change before the steep rise of the differential pressure can still contain a cost or result improvement within the service life of the filter. However, a further configuration can also be the indication to a user, e.g. to inform the user that an additional ventilation by window opening is an energy optimization measure, or e.g. with a corresponding determination of the improvement of the air quality, the secondary filter device can for example reduce the air circulation and thus reduce energy and noise.

According to a further exemplary embodiment, the control unit is configured to control the filter device, in particular the fan unit, variably such that a future energy availability and/or the current and/or future energy consumption of the filter device can be taken into account. The control unit automatically or semi-automatically controls the filter device with approval function based on the future energy availability and/or the current and/or future energy consumption of the filter device and/or of the building. In a further preferred embodiment, the control unit or the sensor element determines data regarding the energy consumption and/or the CO2 footprint of the filter device and/or of the fan unit. A filter medium requires more and more energy for the intended use with increasing occupancy, since the pressure drop Delta P across the filter medium increases due to the filter occupancy. Based on the knowledge of the energy costs and the CO2 footprint of the filter medium due to its production, a recommendation regarding optimal filter change time point (or cleaning time point) can be determined and communicated based on these data, preferably such that individual parameters such as energy costs, saving potential, CO2 savings, CO2 certificate costs etc. can be configured or determined thereby.

According to a further exemplary embodiment, the filter medium comprises a filter material which contains one layer of fleece, in particular multiple layers of fleece, wherein the filter medium can be replaceably arranged in the filter device. The filter medium is in particular a disposable filter. A fleece consists of fibers of limited length, continuous fibers (filaments) or cut yarns, which are joined and connected to form a fleece (a fiber layer, a fiber web). Due to the interlinking of the fibers, an air-permeable material with narrow, small-pored air passages is provided, whereby a good filter effect, in particular of air particles, is achieved.

Since a replaceable filter medium (in particular as a disposable filter) does not have to be adapted exactly to the surrounded housing of the filter device, it is further advantageous if the filter medium prevents possible air resonances. In the case of filter materials of regularly arranged filter medium (e.g. woven, punched, etched or drilled filters), there is the possibility that resonances and thus negative effects arise due to self-organizing effects of the air flow (noises, detachment of already embedded pollutants, in particular during start-up and stop of the plant, in the case of variance of physical measured values, etc.). It has been shown that in the solution according to the invention, the use of a layer of a fleece damps this vibration effect. This damping arises due to the fact that fibers are deposited irregularly and randomly and brought into adhesion. This irregularity reduces the vibration-related self-organization potential. This damping can be increased when using multiple fleece layers in the construction of the filter medium, in particular if these comprise at least slightly different fleece materials or fleece layers. A difference can be generated by the production of fleece materials.

According to a further exemplary embodiment, the filter medium comprises at least two fleece layers and a filter membrane arranged between the fleece layers, which are arranged in a layered manner one above the other in a layer composite. In particular, the middle filter membrane of the layer composite has a larger surface area than the two outer fleece layers.

According to a further exemplary embodiment, a first direction (x-axis) and a second direction (y-axis) span an (xy) plane, wherein the middle filter membrane is corrugated with corrugation sections such that the corrugation sections are arranged one behind the other along the first direction. The corrugation sections run irregularly and asymmetrically to one another in particular within the plane, wherein the filter medium is arranged such that air can flow over the filter medium along the first direction or along the second direction.

For example, the first direction is the air inflow direction of the air. The corrugation sections run transversely to the first direction along the second direction. The asymmetry of the corrugation arrangement and shape can be used for vibration damping. Alternatively, the filter body can also be subjected to flow in the Y-direction and thus parallel to the extent of the corrugations. The corrugation sections thus form, for example, a shark skin-like riblet structure which brings about a reduction of the flow resistance. Depending on the entry conditions (inflow cross-section, volume flow, depth of the filter material to be flowed through) into the filter medium, one or other configuration can be of particular advantage. The asymmetry of the corrugation arrangement can be achieved by a self-organizing compaction process in which the feed rate of the filter membrane is significantly higher than the feed rate of the two cover fleeces. The asymmetry of the corrugation arrangement arises by thermal fixing of the three layers at a predetermined point in time. In addition to the advantages already described, this asymmetry acts in a stabilizing manner on deflections in the x-y plane.

The filter membrane is accumulated in a corrugation form and, for stabilization, is connected at the top and bottom to a cover fleece (adhesively bonded, welded, stapled, etc.). This ensures that sufficiently open membrane regions are available during the service life of the filter medium, and these do not lie flat or fold over in the case of occupancy and thus additionally reduce the passage.

If the non-flat filter membrane is additionally incorporated into the filter medium, the above effects are additionally increased as a result. If the filter medium does not have any sharp edges (as for example in the case of pleated cartridge filters), this has a noise-reducing effect. A good formation of this “non-edginess” is the formation of a sinusoidal impact zone.

A higher resistance for the air flowing past is generated by the corrugated filter construction with the riblet structure. If the filter medium is now arranged longitudinally or obliquely with respect to the air flow, an air flow enveloping the main air flow (or accompanying it laterally if a filter medium is only partially mounted) arises at low velocity. The sound of the air flow is damped by the reduced velocity. When the air flows along the corrugated filter construction, a defined extent of the air flow flows through the corrugated filter medium, similarly to in the case of a pipe muffler or absorption muffler, with which the mass flow of the main air flow is reduced and, as explained above, the flow velocity of the main air flow is reduced, so that the sound of the air flow is damped.

According to a further exemplary embodiment, the filter medium has a thickness of 2 mm to 10 mm, in particular of 3 mm to 7 mm, and/or the number of corrugation sections is between 0.5 and 3 corrugations per cm.

This allows a filter performance similar to a HEPA filter, but with a pressure drop in the region of a normal F7 filter (i.e. within the operating parameters of the solution according to the invention).

According to a further exemplary embodiment, a surface area of the filter membrane is more than 30% larger, in particular more than 80% larger, further in particular more than 200% larger than the respective surface area of the outer fleece layers. In particular, good sound emission reductions have resulted when the area of the filter membrane is more than 30% larger, in particular more than 80% larger, preferably more than 200% larger than the filter area, in particular the filter surface of the outer fleece layers. This is explained by the diffusion effect of the filter membrane when it is not a flat-lying element (with possible acoustic reflection effect).

According to a further exemplary embodiment, the filter device has a weighing device which is configured to weigh the filter occupancy, in particular such that a measured value falsification by the pressure of the air flowing through the system can be compensated. With corresponding additional mechanisms, a compensation of the measured value falsification of the sensor element by the pressure of the air resistance can be achieved during operation of the filter device. This also allows the determination of a high filter occupancy of the filter medium for an operating mode of the filter device with a low (low) volume flow which does not lead to the triggering of the differential pressure monitoring of the filter medium in the case of customary filter monitoring. In particular in secondary filter devices, efforts are made to operate with low, low pressure differences, so that the noise level remains deep or low. This detail allows a reliable measurement of the filter occupancy despite very low pressure differences. In particular, the weighing device can have a ground contact in the installed state of the filter medium in the housing of the filter device and thus introduce the weight force of the filter medium to the ground. As a result, a weight measurement of the filter medium can be carried out.

According to a further exemplary embodiment, the filter medium comprises a filter material which is hydrophobic and/or contains a natural fiber or a polyolefin, in particular a polypropylene, in particular such that the filter contains cellulose, cotton and/or hemp. If the air flow to be filtered is contaminated with a high aerosol load, known filters can have a tendency to undergo abrupt moistening. This can on the one hand statically increase the pressure drop across the filter, but also dynamically overcharge a subsequent volume flow regulation by means of VAV in the sense of its regulation speed due to the very rapidly changing pressure conditions. The solution according to the invention can solve this problem by a suitable material selection of the filter material. Either a hydrophobic material (e.g. a polyolefin, in particular polypropylene, which is substantially free of polar groups) and/or an absorbent material having a special (for example less, lower) tendency to swell (e.g. a natural fiber, in particular a cellulose fiber, cotton or hemp) is used. Thus, the tendency of filling filter openings with micro- or nanoscale water droplets is reduced. It has been shown that the fungicidal, virucidal and bactericidal properties of hemp are favorable and make it an ideal filter constituent. This reduction of the pressure drop also leads to less location-unstable measurements (i.e. that in the case of a smaller pressure drop more air is sucked through and therefore a larger location image is relevant for the measured values than is expected in the assessment as a composite).

According to a further exemplary embodiment, the filter medium comprises a vibro-acoustic metamaterial. Vibro-acoustic metamaterials consist of a periodic arrangement of small resonator structures which are distributed in an array and which are constructed per se from multiple materials. In this case, the order of magnitude of the resonators can be smaller than half the wavelength of the oscillation to be reduced. Vibro-acoustic metamaterials can be produced cost-effectively. The vibro-acoustic metamaterials can line a part of the air guidance and thus damp the sound. In addition, they can be tuned to the most disturbing natural resonance frequency of the secondary filter device and, depending on the embodiment, reduce the sound emissions by a further 1.5 to 10 dB.

According to a further exemplary embodiment, the filter device has a housing in which the filter medium and the fan unit are arranged. The housing can be arranged in a room of a building and is designed, for example, as a room divider. Furthermore, the housing can comprise a lamp and can be configured as a light. Furthermore, the housing can comprise a loudspeaker. Furthermore, the housing can comprise a sound-absorbing layer and can be configured as a sound muffler and/or as a sound absorber. Thus, in a further especially preferred embodiment, the secondary filter device can be connected to at least one further room-relevant additional function. This can be a room design element, a room divider, a light, a loudspeaker or a sound muffler. By this combination, a saving of material (for example for the housing) is achieved compared to the respective independent stand-alone devices.

In the noise reduction, it is essential that the design of the filter device selectively distinguishes between laminar and turbulent flow and the corresponding sound emissions are selectively minimized. Thus, it has been recognized that by the above-described measures according to the invention, e.g. a replaceable filter (in particular a disposable filter) does not have to be adapted exactly to the surrounding container and nevertheless possible air resonances can be prevented. In the case of filter devices of regularly arranged filter medium (e.g. woven, punched, etched or drilled filters), there is the possibility that resonances and thus negative effects arise due to self-organizing effects of the air flow (noises, detachment of already embedded pollutants [in particular during start-up and stop of the plant], variance of physical measured values, etc.). It has turned out that in a solution according to the invention, the use of only one layer of a fleece already damps this vibration effect. Of course, this damping is increased in the case of multiple fleece layers in the construction of the filter medium, in particular if these are at least slightly different. This is explained by the production of fleece materials. For this purpose, fibers are normally deposited irregularly/randomly and brought into adhesion. This irregularity reduces the vibration-related self-organization potential, which can lead to more noise.

The filter surfaces, which are especially large for acoustic reasons, are also predestined as sound mufflers. In particular, in combination with special sound materials (for example melanin resins), a particularly good degree of sound insulation (both for sound from the outside and also for noises of the filter plant itself) can be achieved with a sufficient volume flow.

It is pointed out that the embodiments described here merely represent a limited selection of possible embodiment variants of the invention. Thus, it is possible to combine the features of individual embodiments with one another in a suitable manner, such that a plurality of different embodiments are to be regarded as obviously disclosed for the person skilled in the art with the embodiment variants explicit here. In particular, some embodiments of the invention are described with device claims and other embodiments of the invention are described with method claims. However, it will immediately become clear to the person skilled in the art when reading this application that, unless explicitly stated otherwise, in addition to a combination of features which belong to a type of subject matter of the invention, an arbitrary combination of features which belong to different types of subject matter of the invention is also possible.

### BRIEF DESCRIPTION OF THE DRAWINGS

Exemplary embodiments are described in more detail below with reference to the accompanying drawings for further explanation and for better understanding of the present invention.

FIG. 1 shows a schematic illustration of a filter device according to an exemplary embodiment of the present invention.

FIG. 2 shows a schematic illustration of a room with exemplary embodiments of the filter device according to the invention.

FIG. 3 shows a schematic illustration of a filter medium with a wave-shaped filter membrane according to an exemplary embodiment.

FIG. 4 shows a schematic illustration of a filter medium with a wave-shaped filter membrane and corrugated cover layers according to an exemplary embodiment.

FIG. 5 shows a schematic illustration of corrugation forms of the filter medium according to an exemplary embodiment.

FIG. 6 shows a schematic illustration of a filter medium with a dynamic pressure gauge according to an exemplary embodiment.

FIG. 7 shows a diagram of a pressure drop of air flowing through the filter over the operating time of the filter medium.

FIG. 8 shows a schematic illustration of an active noise reduction according to an exemplary embodiment.

### DETAILED DESCRIPTION OF EXEMPLARY EMBODIMENTS

Identical or similar components in different figures are provided with identical reference numerals. The illustrations in the figures are schematic.

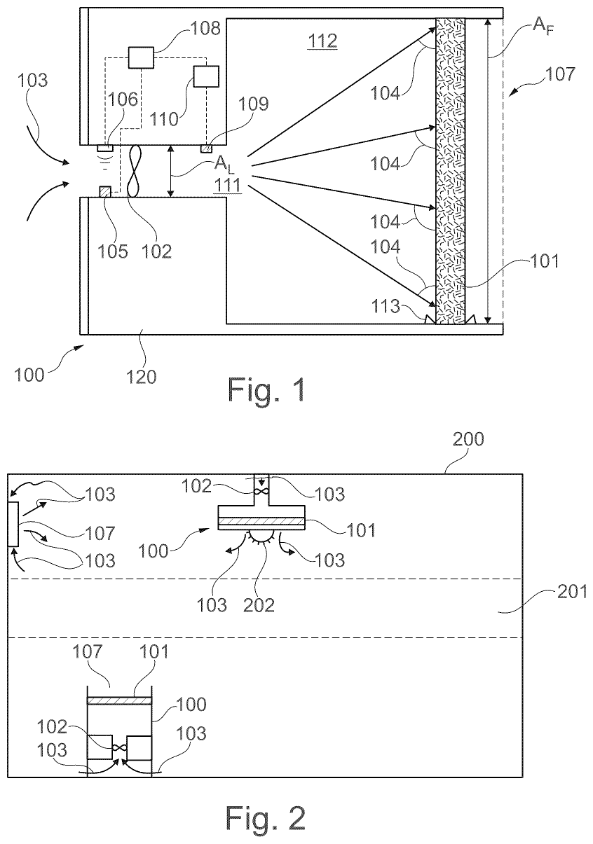

FIG. 1 shows a filter device 100 for filtering air 103 in a room 200 (see FIG. 2) of a building. The filter device 100 comprises a filter medium 101 and a fan unit 102, wherein air 103 to be filtered can be flowed through the filter medium 101 for filtering by means of the fan unit 102. A filter area of the filter medium 101 is five times larger than a smallest air flow cross-section in the fan unit 102, such that an air flow angle 104 between the flow direction of the air 103 during filter entry into the filter medium 101 and a filter surface of the filter medium 101 differs from 90 degrees and the sound pressure level of the filter device 100 at a distance of one meter from the filter device 100 at a volume flow rate above 50 m³/h of the air 103 driven by the fan unit 102 is below 48 dB, wherein the filter medium 101 is configured such that the pressure drop of the air 103 which flows through the filter medium 101 is less than 450 Pascal.

The filter device 100 comprises, for example, a housing 120 in which a filter medium 101 is arranged or a plurality of filter media 101 are arranged in series along the flow direction of the air 103 through the filter device 100 or parallel to the flow direction. The filter medium 101 can be replaceably provided.

The filter medium 101 of the filter device 100 comprises, for example, a flat filter material which is fixed in a circumferential support frame. The filter medium 101 can be designed as a pocket filter, wherein a plurality of pockets of filter medium 101 are fastened in the support frame and the air flow is introduced into the pockets in order to filter the inflowing air 103.

The fan unit 102 of the filter device 100 in particular sucks air 103 to be filtered into the filter device 100, so that the air 103 flows through the filter medium 101. The fan unit 102 can comprise, for example, an axial compressor or a radial compressor and accordingly the air 103 can flow in a straight line or at right angles along a translational flow. The fan unit 102 can in particular be controlled by the control unit 108, so that the air throughput through the filter device 100 can be adjusted. The fan unit 102 is in particular a secondary air circulation system with filtering for installation in a room 200 (so-to-speak a “room air cleaner”). The filter device 100 can be mobile or stationary.

According to the invention, the filter area AF of the filter medium 101 is five times larger than a smallest air flow cross-section AL in the fan unit 102. The smallest air flow cross-section AL describes the smallest flow cross-section in the air path of the air 103 through the filter device 100, i.e. between the entry of the air 103 into the flow channel 111 of the fan unit 102 and the exit of the air 103 from the flow channel 112 of the filter medium 101. The smallest flow cross-section AL can, for example, be present in an air channel of the filter device 100 in which a flow-generating element (e.g. a fan) of the fan unit 102 is arranged.

The filter medium 101 is arranged in particular downstream of the smallest air flow cross-section AL. Between the smallest air flow cross-section AL and the filter medium 101, the air flow cross-section of the air path through the filter device 100 widens, so that the air 103 strikes a filter medium 101 which comprises a filter area AF which is five times larger than the smallest air flow cross-section AL in the fan unit 102.

Between the filter medium 101 and the smallest air flow cross-section AL, there is exclusively a widening of the air flow path, so that the one linear portion of the air flow against the filter medium 101 flow direction during filter entry differs from 90 degrees to a filter surface of the filter medium 101 and comprises an air flow angle 104 between the flow direction and the filter surface not equal to 90 degrees. In particular, the filter surface is parallel to the smallest air flow cross-section AL or parallel to an air flow cross-section AL before the widening of the air flow path begins.

The widening region further forms a long expansion zone without, for example, hard transitions after the fan unit 102. Especially good results were found when the expansion zone is larger or longer than the cross-section AL of the air flow, in particular more than twice or even four times the cross-section of the air flow.

When the air guidance is constructed in such a way that the main flow direction of the air 103 at the filter surface at the inlet of the filter medium 101 is not guided in a straight line through the filter medium 101, but instead a deflection, for example of more than 10 degrees, takes place for the majority, a rotational movement is introduced precisely for larger particle or aerosol portions of the air 103, which achieve a better separation rate on a filter (in particular in combination effect with multi-layer porous filter together with cyclone separation effect). The cyclone separation effect allows a more stable binding of the foreign substances. The inertial movement of heavier air flow portions achieved by the air deflection leads to a better adherence to the filter material in the filter medium 101 and thereby a better separation rate.

By means of this widening of the flow cross-section it is achieved that the sound pressure level of the filter device 100 at a distance of one meter from the filter device 100 (in particular from the air outlet and/or the air inlet of the filter device 100) at a volume flow rate above 50 m³/h of the air 103 driven by the fan unit 102 is below 48 dB.

Since the filter area AF is significantly larger than the inflow cross-section or the air flow cross-section AL in the fan unit 102 of the air 103 to be cleaned, a change in velocity of the air flow also takes place as a result. Highly accelerated heavy solid fractions (or aerosols) reduce their velocity more slowly than the light air molecules. This means that they strike the filter medium 101 relatively strongly, which in turn leads to a good adherence to the filter (and thus to a particularly good depletion).

The filter device 100 comprises a control unit 108 for controlling the fan unit 102, wherein the control unit 108 is coupled to the fan unit 102 for a wireless or wired signal exchange of control commands. The control unit 108 can be integrated in the filter device 100 and control the fan unit 102.

The filter device 100 further comprises a sensor element 109 for determining at least one air parameter (e.g. CO content, CO₂ content, rel. air humidity, air pressure, O₂ content, temperature, PM content, aerosol concentration, type and/or concentration of foreign substances) of the air 103 to be filtered at the filter device 100 or an operating parameter of the filter device 100. The control unit 108 is coupled for a wireless (or wired) signal exchange of sensor signals of the sensor element 109. The control unit 108 is configured in particular such that a warning signal can be generated on the basis of the filter-related data and/or a measure can be taken which relates to a throughput through the filter device 100 (e.g. control of the fan unit) or relates to functions of the filter device 100 which are blocked or released.

The filter device 100 and the control unit 108 can each comprise an antenna or a conductor-based system which signals the readiness of the filter device 100 to exchange data.

The filter device 100 further has a data storage unit 110, which is coupled to the control unit 108, to the fan unit 102 and to the sensor element 109 for exchanging data, wherein in particular the data can be protected by means of a certificate and/or an encryption. The data represent in particular measured values, which are selected from the group consisting of air throughput through the filter device 100, air temperature, air pressure, in particular absolute pressure and/or differential pressure, filter occupancy of the filter medium, air humidity, aerosol loading, PM content and/or foreign substance fraction of the air 103, measuring location of the air measurement. Especially in the case of demanding operating conditions, it can be of interest that individual detection details, such as the measured values, can be parameterized. On the one hand, this relates to details of the measuring method, on the other hand also the parameters which are to be recorded (e.g. air throughput, temperature, pressure (in particular absolute pressure and/or differential pressure), filter occupancy, humidity, aerosol loading, PM content, in particular also how much of which diameter class). Such a data record can then in turn be transmitted by means of a communication or can only be read out after the end of the filter service life.

The filter device 100 further comprises a weighing device 113 which is configured to weigh the filter occupancy, in particular such that a measured value falsification by the pressure of the air 103 flowing through the system can be compensated. With corresponding additional mechanisms, a compensation of the measured value falsification of the sensor element 109 by the pressure of the air resistance can be achieved during operation of the filter device 100. This also allows the determination of a high filter occupancy of the filter medium 101 for an operating mode of the filter device 100 with a low (little) volume flow which does not lead to the triggering of the differential pressure monitoring of the filter medium 101 in the case of customary filter monitoring.

FIG. 2 shows a schematic illustration of a room 200 with exemplary embodiments of the filter device 100 according to the invention. The filter device 100, e.g. the housing 120 thereof, has an air outlet 107 for blowing out the air 103, wherein the filter device 100 is formed such that the air outlet 107 is lower than 1 m, in particular lower than 0.5 m, above the ground (on which the filter device 100 rests) and thus below a head height 201 of a standing person. Additionally or alternatively, the filter device 100 is formed such that the air outlet 107 is higher than 1.8 m, in particular higher than 2 m, than a head height 201 of a standing person.

The housing 120 can be arranged in a room 200 of a building and is designed, for example, as a room divider. Furthermore, the housing 120, as illustrated, can comprise a lamp 202 and can be configured as a light. In addition, the filter device 100 can also be mounted on a wall of a room 200.

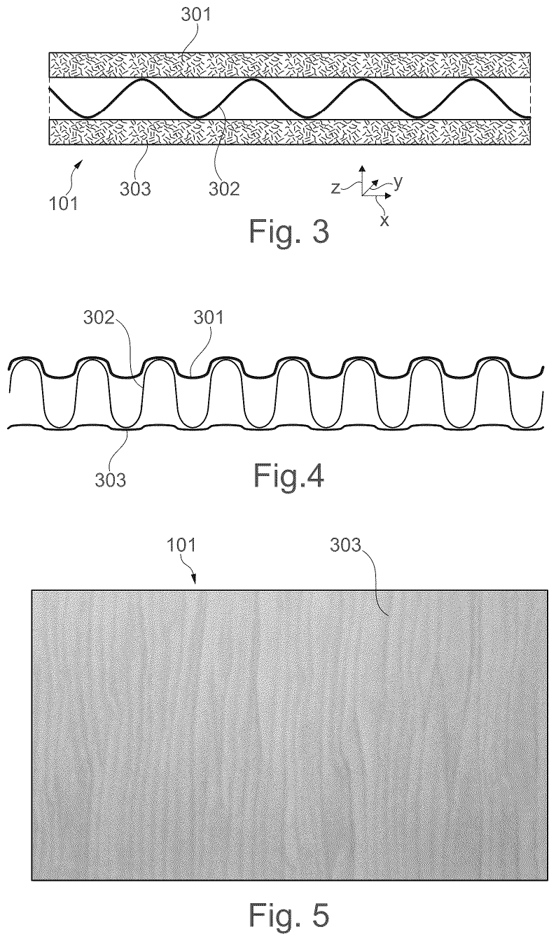

FIG. 3 shows a schematic illustration of a filter medium 101 with a wave-shaped filter membrane according to an exemplary embodiment. The filter medium 101 comprises, in particular multiple, filter layers (e.g. fleece layers) 301, 302, 303 which are arranged one behind the other in the flow direction of the air 101 through the filter medium 101, wherein, in particular, the first filter layer 301 facing the supply air side filters more coarsely than at least one of the second filter layers 302, 303 following the following first filter layer in the flow direction. Thus, coarser particles can be filtered at first, while smaller particles flow through the first layers and are filtered out only later in the case of the fine layers.

The outer filter layers are arranged as fleece layers 301, 303 and a filter layer is arranged as a filter membrane 302 between the fleece layers 301, 303. The fleece layers 301, 302, 303 are arranged in a layered manner one above the other in a third direction z in a layer composite, wherein, in particular, the middle filter membrane 302 of the layer composite has a larger surface area than the two outer fleece layers 301, 303. The middle filter membrane 302 comprises corrugation sections which are arranged one behind the other along a first direction x.

FIG. 4 shows a schematic illustration of a filter medium 101 with a wave-shaped filter membrane 302 and corrugated cover layers as fleece layers 301, 303 according to an exemplary embodiment.

On the supply air side, a coarse cover fleece can be provided as an outer fleece layer 301, which is arranged in particular in a corrugated manner on the supply air side of the filter membrane 302. A cover fleece can also be arranged as a fleece layer 303 on the exhaust air side of the filter membrane 502. The outer fleece layer 301 on the supply air side is corrugated more strongly than the outer fleece layer 303 on the exhaust air side. The filter membrane 302 is strongly corrugated and accordingly also strongly filtering. The intermediate region between the outer fleece layers 301, 303 and the corrugations of the filter membrane 302 can be filled with a film material in order to achieve a higher stability.

FIG. 5 shows a schematic illustration of corrugation forms of the filter medium 101 according to an exemplary embodiment. The corrugation sections run irregularly and asymmetrically to one another in particular within the plane. The filter medium 101 is arranged such that air 101 can flow over the filter medium 101 along the first direction x or along the second direction y. For example, the x direction is the air inflow direction of the air 101 and the corrugation sections run transversely to the first direction x along the second direction y. The asymmetry of the corrugation arrangement and shape can be used for vibration damping.

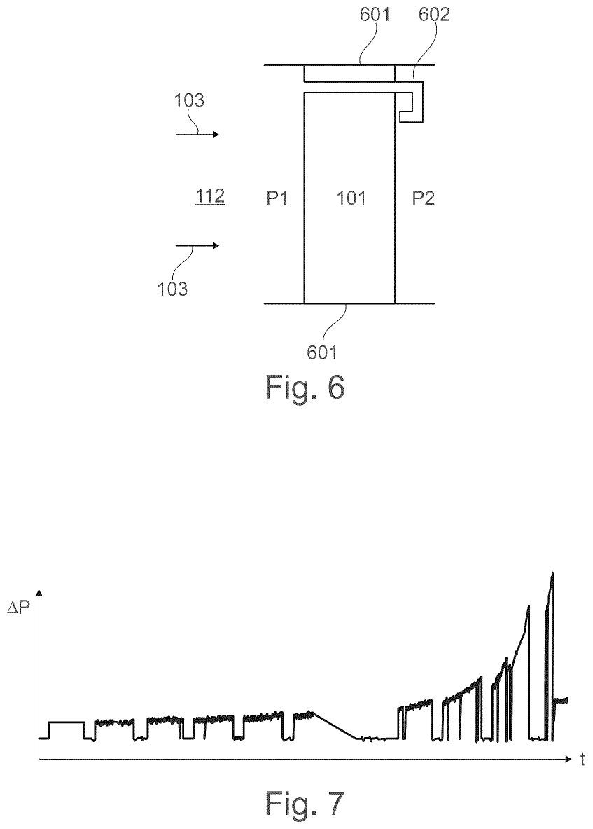

FIG. 6 shows a schematic illustration of a filter medium 101 with a dynamic pressure gauge 602 according to an exemplary embodiment.

The dynamic pressure gauge 602 is formed such that a static pressure upstream of the filter medium 101 and a static and dynamic pressure downstream of the filter medium 101 on the exhaust air side can be measured. If the velocity of the air flow is high enough, the differential pressure p1-p2 between a normal pressure tap upstream of the filter medium 101 (pressure p1) and a dynamic pressure pipe (or Pitot pipe) downstream of the filter medium 101 (pressure p2) can be measured. The filter medium 101 is arranged within an air channel which is formed by walls as an outer air flow boundary 601. The pressure at the Pitot pipe is given by the sum of the static pressure and the dynamic pressure and is therefore higher than at the normal pressure tap upstream of the filter medium 101. This configuration creates an inverted or negative differential pressure across the filter medium 101 and allows clogged supply lines or flap faults to be detected.

FIG. 7 shows a diagram of a pressure drop of air 103 flowing through the filter over the operating time of the filter medium 101. It is shown in the diagram that the pressure drop ΔP of the through-flowing air 103 through the filter medium 101 increases over the operating time t due to the filter occupancy. The filter medium 101 is configured here (for example via the material/pore density, the material selection and/or the thickness of the filter medium 101) such that the pressure drop (between entry into the filter medium 101 and exit from the filter medium 101) of the air 103 which flows through the filter medium 101 is less than 450 Pascal in a regular predefined operating cycle defined by a predefined operating time.

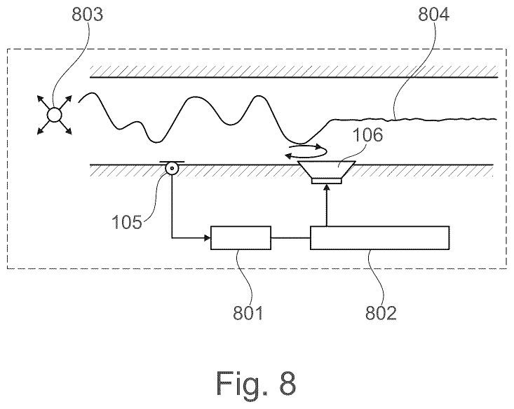

FIG. 8 shows a schematic illustration of an active noise reduction according to an exemplary embodiment. The filter device 100 has a microphone unit 105 and a sound generator 106, wherein the microphone unit 105 is arranged to measure the sound level 804 of the air 103 as a noise source 803 before the fan unit 102 and/or after the filter medium 101, wherein the sound generator 106 is configured to generate a counter sound based on the measured sound level 804. An active noise suppression can thus be integrated. The sound generator 106 thereby generates sound which is adjusted such that it is adjustable with a destructive interference with respect to the noise source 803 which is generated by the air flow. For this purpose, a controller 101 (for example the control unit 108) is coupled to the microphone unit 105 in order to generate signals for the sound generator 106. These signals can be amplified in a power amplifier 802.

In addition, it should be noted that “comprising” does not exclude any other elements or steps and “a” or “an” does not exclude a plurality. Furthermore, it should be pointed out that features or steps which have been described with reference to one of the above exemplary embodiments can also be used in combination with other features or steps of other exemplary embodiments described above. Reference signs in the claims are not to be regarded as a restriction.

List of Reference Signs:

100 Filter device
101 Filter medium
102 Fan unit
103 Air
104 Air flow angle
105 Microphone unit
106 Sound generator
107 Air outlet
108 Control unit
109 Sensor element
110 Data storage unit
111 Flow channel fan unit
112 Flow channel filter medium
113 Weighing device
120 Housing
200 Room
201 Head height of a standing person
202 Lamp
301 First fleece layer
302 Filter membrane
303 Second fleece layer
601 Outer air flow boundary
602 Dynamic pressure gauge
801 Controller
802 Power amplifier
803 Noise source
804 Sound level
x First direction
y Second direction
z Third direction
p1 Pressure supply air side
p2 Pressure exhaust air side
AL Air flow cross-section fan unit
AF Filter area filter medium

1. A filter device for filtering air in a room of a building, the filter device comprising:
a filter medium; and
a fan unit,
wherein air to be filtered can be flowed through the filter medium for filtering by means of the fan unit,
wherein a filter area of the filter medium is five times larger than a smallest air flow cross-section in the fan unit, such that an air flow angle between the flow direction of the air during filter entry into the filter medium and a filter surface of the filter medium differs from 90 degrees and the sound pressure level of the filter device at a distance of one meter from the filter device at a volume flow rate above 50 m³/h of the air driven by the fan unit is below 48 dB,
wherein the filter medium is configured such that the pressure drop of the air which flows through the filter medium is less than 450 Pascal.

2. The filter device according to claim 1,
wherein the filter area of the filter medium is formed larger than a smallest air flow cross-section in the fan unit, such that at a distance of one meter the sound pressure level of the filter device is below 45 dB.

3. The filter device according to claim 1,
wherein the filter medium is formed such that a pressure drop of the through-flowing air through the filter medium is below 250 Pa.

4. The filter device according to claim 1, at least one of a) wherein the filter area of the filter medium is 10 times larger than a smallest air flow cross-section in the fan unit and
b) wherein the filter medium is formed with a filter area, AF, larger than 1 m².

5. The filter device according to claim 1, comprising at least one of the following features:
i) at least one of a) wherein the filter device is configured such that an air volume per hour and square meter of filter area is below 600 m³/(m²×h), and
b) the velocity of the volume flow of the air through the filter device is in the range 0.1 to 5 m/s;
ii) further comprising
a microphone unit, and
a sound generator,
wherein the microphone unit is arranged to measure the sound level of the air at least one of before the fan unit and after the filter medium,
wherein the sound generator is configured to generate a counter sound based on the measure sound level;
iii) further comprising
an air outlet for blowing out the air,
at least one of a) wherein the filter device is formed such that the air outlet is lower than 1 m above the ground, and
b) wherein the filter device is formed such that the air outlet is higher than 1.8 m above the ground.

6-7. (canceled)

8. The filter device according to claim 1, further comprising:
a control unit for controlling the fan unit,
wherein the control unit is coupled to the fan unit for a wireless signal exchange of control commands.

9. The filter device according to claim 8, further comprising
a sensor element for determining at least one air parameter of the air to be filtered at the filter device or an operating parameter of the filter device.

10. The filter device according to claim 9,
at least one of a) wherein the sensor element is a dynamic pressure gauge, and
b) wherein the sensor element comprises a microphone which is configured to detect the noise level in a room such that the number and intensity of speech-active persons in the room can be determined by means of measurement and evaluation of the noise level in the room.

11. The filter device according to claim 8, wherein the control unit obtains a UniqueID from the filter device, wherein the UniqueID comprises information regarding the location of use of the filter device, wherein the control unit receives the UniqueID via NFC, Bluetooth, WLAN, proprietary protocols or protocols of building control systems, wherein at least one of the operation and the configuration of the filter device can be adjusted based on the UniqueID.

12. The filter device according to claim 9, further comprising:
a data storage unit, which is coupled to the control unit, to the fan unit and to the sensor element for exchanging data.

13. The filter device according to claim 9, wherein the sensor element is configured to determine at least one of an energy consumption and a CO2 footprint of the filter device based on at least one of the air parameter and the operating parameter of the filter device.

14. The filter device according to claim 8,
wherein the control unit is configured to control the filter device variably such that at least one of a future energy availability and the current and future energy consumption of the filter device can be taken into account,
wherein the control unit automatically or semi-automatically controls the filter device with approval function based on at least one of the future energy availability and the current and future energy consumption of at least one of the filter device and of the building.

15. The filter device according to claim 1,
wherein the filter medium comprises a filter material which contains one layer of fleece,
wherein the filter medium can be replaceably arranged in the filter device.

16. The filter device according to claim 15,
wherein the filter medium comprises at least two fleece layers and a filter membrane arranged between the fleece layers, which are arranged in a layered manner one above the other in a layer composite.

17. The filter device according to claim 16,
wherein a first direction, x, and a second direction, y, span a plane,
wherein the middle filter membrane is corrugated with corrugation sections such that the corrugation sections are arranged one behind the other along a first direction, x,
wherein the corrugation sections run irregularly and asymmetrically to one another, and
wherein the filter medium is arranged such that air can flow over the filter medium along the first direction, x, or along the second direction, y.

18. The filter device according to claim 17,
at least one of a) wherein the filter medium has a thickness of 2 mm to 10 mm, and
b) wherein the number of corrugation sections is between 0.5 and 3 corrugations per cm.

19. The filter device according to claim 15, wherein a surface area of the filter membrane is more than 30% larger than the respective surface area of the outer fleece layers.

20. The filter device according to claim 1, comprising at least one of the following features:
i) further comprising
a weighing device which is configured to weigh the filter occupancy;
ii) wherein the filter medium comprises a filter material which at least one of a) is hydrophobic and b) contains a natural fiber or a polyolefin;
iii) wherein the filter medium comprises a vibro-acoustic metamaterial.

21-22. (canceled)

23. The filter device according to claim 1, further comprising:
a housing in which the filter medium and the fan unit are arranged,
wherein the housing can be arranged in a room of a building and is designed as a room divider, or
the housing comprises a lamp and is configured as a lamp, or
wherein the housing comprises a loudspeaker, or
wherein the housing comprises a sound-absorbing layer and can be configured as at least one of a sound muffler and as a sound absorber.

24. A method for filtering air in a room of a building using a filter device according to claim 1.
